(19) United States
(12) Patent Application Publication
(10) Pub. No.: US 2025/0122111 A1
(43) Pub. Date: Apr. 17, 2025

(54) WET AIR OXIDATION OF WASTEWATER SLUDGE SOLIDS

(71) Applicant: Lummus Technology LLC, Houston, TX (US)

(72) Inventor: Chad Felch, Kronenwetter, WI (US)

(21) Appl. No.: 18/911,507

(22) Filed: Oct. 10, 2024

Related U.S. Application Data
(60) Provisional application No. 63/590,038, filed on Oct. 13, 2023.

(51) Int. Cl. C02F 9/00; C02F 1/00; C02F 3/12; C02F 11/04; C02F 11/08; C02F 11/127; C02F 11/13

(52) U.S. Cl. CPC C02F 9/00; C02F 2001/007; C02F 3/12; C02F 11/04; C02F 11/08; C02F 11/127; C02F 11/13; C02F 2301/046

(57) ABSTRACT

Methods of and systems for treating the sludge solids of a wastewater stream are provided. The wastewater treatment includes a wet air oxidation (WAO) treatment upstream from an anaerobic sludge digestion. The disclosed methods and systems provide a reduction in the amount of sludge solids requiring disposal, in favor of an increase in the amount of fuel gas produced by the treatment system.

### CROSS-REFERENCE TO RELATED APPLICATIONS

This application claims priority to and the benefit of U.S. Provisional Patent Application No. 63/590,038, filed Oct. 13, 2023, the entire disclosure of which is incorporated by reference herein.

### FIELD

The present disclosure relates to methods of and systems for treating the sludge solids of a wastewater stream. More particularly, the present disclosure relates to a wastewater treatment method including a wet air oxidation (WAO) treatment step upstream from an anaerobic sludge digestion step. The disclosed methods and systems provide a reduction in the amount of sludge solids requiring disposal, in favor of an increase in the amount of fuel gas produced by the treatment system.

### BACKGROUND

The effective handling of municipal sewage and industrial wastewater requires the treatment of sludge solids and organic waste. Conventionally, wastewater sludge solids have been transported for incineration or disposal in either landfills or the agriculture domain. However, these types of disposal have recently come under scrutiny due to the presence of perfluoroalkyl and polyfluoroalkyl substances (“PFAS”), colloquially known as “forever chemicals,” in the sludge. It has been noted that the presence of PFAS in substances applied to farm fields produces the downstream presence of PFAS in both crops and livestock, which thus results in a domestic food supply contaminated with these chemicals. In light of the increased awareness of both the dangers and pervasiveness of PFAS contamination, some states are beginning to ban the cropland application of wastewater sludge, and as well as the amount of sludge permitted in landfills. As a result of these limitations and/or outright bans, the cost associated with disposing of wastewater sludge has increased significantly.

As such, in order to comply with these changing regulations surrounding sludge disposal, a need exists for wastewater treatment methods which reduce the amount of wastewater sludge requiring disposal.

### SUMMARY

Disclosed herein are methods of and systems for treating wastewater sludge via wet air oxidation (WAO). The methods and systems include a secondary treatment unit 101, a wet air oxidation (WAO) unit 102, and a digester 103.

In accordance with a first aspect of the present disclosure, a method of treating wastewater is provided. The method includes directing a wastewater stream into a secondary treatment unit 101, wherein the secondary treatment unit 101 provides biological treatment of the wastewater stream and produces a treated sludge stream 28; directing the treated sludge stream into a solids thickening device 106, wherein the solids thickening device 106 separates the treated sludge stream 28 into a centrate stream 30 and a sludge solids stream 32; directing the sludge solids stream 32 into a wet air oxidation (WAO) unit 102, wherein the WAO unit solubilizes the sludge solids stream 32 by wet air oxidation to provide a WAO effluent stream 34; separating the WAO effluent stream 34 into a solid slurry stream 36 and a decanted liquid stream 38; and directing the decanted liquid stream 38 into a digester 103, wherein the decanted liquid stream 38 is subjected to anaerobic digestion to produce a digester gas stream 44, wherein the digester gas stream 44 comprises methane, carbon dioxide, and hydrogen.

In a second aspect of the disclosure, which may be combined with any other aspect listed herein unless specified otherwise, the method of treating wastewater includes a step of removing a recycled sludge stream 42 from the digester 103, and directing the recycled sludge stream 42 into the solids thickening device 106.

In a third aspect of the disclosure, which may be combined with any other aspect listed herein unless specified otherwise, the method of treating wastewater includes a step of processing the digester gas stream 44 to provide a product methane source for fuel or chemical manufacturing.

In a fourth aspect of the disclosure, which may be combined with any other aspect listed herein unless specified otherwise, the method of treating wastewater includes a step of directing the solid slurry stream 36 to a dryer 108 to produce a sludge disposal stream 40.

In a fifth aspect of the disclosure, which may be combined with any other aspect listed herein unless specified otherwise, the method of treating wastewater includes a step of removing a supernatant stream 46 from the digester 103, and directing the supernatant stream 46 into the secondary treatment unit 101.

In a sixth aspect of the disclosure, which may be combined with any other aspect listed herein unless specified otherwise, the method of treating wastewater includes a step of directing the centrate stream 30 into the secondary treatment unit 101.

In a seventh aspect of the disclosure, which may be combined with any other aspect listed herein unless specified otherwise, the method of treating wastewater includes a step of clarifying the wastewater stream 20 in a primary treatment unit 104 upstream from the secondary treatment unit 101.

In an eighth aspect of the disclosure, which may be combined with any other aspect listed herein unless specified otherwise, the method of treating wastewater includes a step of clarifying the treated sludge stream 28 in a secondary clarifier 105 upstream from the solids thickening device 106.

In a ninth aspect of the disclosure, which may be combined with any other aspect listed herein unless specified otherwise, the method provides a reduction in volatile solids (VSR) from the wastewater stream 20 to the digester gas stream 44 of at least 50%.

In a tenth aspect of the disclosure, which may be combined with any other aspect listed herein unless specified otherwise, the method provides a reduction in volatile solids (VSR) from the wastewater stream 20 to the digester gas stream 44 of at least 80%.

In accordance with an eleventh aspect of the present disclosure, a wastewater treatment system 100 is provided. The system includes a secondary treatment unit 101 configured to provide biological treatment of a wastewater stream 20; a wet air oxidation (WAO) unit 102 downstream from the secondary treatment unit 101, wherein the WAO unit is configured to solubilize a sludge solids stream 32 by wet air oxidation to provide a WAO effluent stream 34; a means for separating the WAO effluent stream 34 into a solid slurry stream 36 and a decanted liquid stream 38; and a digester 103 downstream from the WAO unit, wherein the digester is configured to subject the decanted liquid stream 38 to anaerobic digestion to produce a digester gas stream 44, wherein the digester gas stream 44 comprises methane, carbon dioxide, and hydrogen.

In a twelfth aspect of the disclosure, which may be combined with any other aspect listed herein unless specified otherwise, the wastewater treatment system includes a recycled sludge stream 42 configured to flow from the digester 103 into a solids thickening device 106 upstream from the WAO unit 102.

In a thirteenth aspect of the disclosure, which may be combined with any other aspect listed herein unless specified otherwise, the solids thickening device 106 is configured to provide the sludge solids stream 32 and a centrate stream 30.

In a fourteenth aspect of the disclosure, which may be combined with any other aspect listed herein unless specified otherwise, the sludge solids stream 32 is configured to flow from the solids thickening device 106 into the WAO unit 102.

In a fifteenth aspect of the disclosure, which may be combined with any other aspect listed herein unless specified otherwise, the wastewater treatment system includes a dryer 108 configured to process the solid slurry stream 36 to produce a sludge disposal stream 40.

In a sixteenth aspect of the disclosure, which may be combined with any other aspect listed herein unless specified otherwise, the wastewater treatment system includes a supernatant stream 46 configured to flow from the digester 103 into the secondary treatment unit 101.

In a seventeenth aspect of the disclosure, which may be combined with any other aspect listed herein unless specified otherwise, the centrate stream 30 is configured to flow from the solids thickening device 106 into the secondary treatment unit 101.

In an eighteenth aspect of the disclosure, which may be combined with any other aspect listed herein unless specified otherwise, the wastewater treatment system includes a primary treatment unit 104 upstream from the secondary treatment unit 101.

In a nineteenth aspect of the disclosure, which may be combined with any other aspect listed herein unless specified otherwise, the wastewater treatment system includes a secondary clarifier 105 downstream from the secondary treatment unit 101 and upstream from the WAO unit 102.

In a twentieth aspect of the disclosure, which may be combined with any other aspect listed herein unless specified otherwise, the wastewater treatment system provides a reduction in volatile solids (VSR) from the wastewater stream 20 to the digester gas stream 44 of at least 80%.

In a twenty-first aspect of the disclosure, which may be combined with any other aspect listed herein unless specified otherwise, the system the digester 103 is configured to receive only the decanted liquid stream 38 as an inlet stream.

### DESCRIPTION OF THE FIGURE

The advantages of the inventive concepts will be apparent upon consideration of the following detailed disclosure, especially when taken in conjunction with the accompanying drawing wherein:

FIG. 1 illustrates a block flow diagram of an exemplary wastewater treatment system in accordance with the present disclosure.

### DETAILED DESCRIPTION

Disclosed herein are methods of and systems for treating the sludge solids of a wastewater stream. While the present disclosure describes certain embodiments of the methods and systems in detail, the present disclosure is to be considered exemplary and is not intended to be limited to the disclosed embodiments.

As used herein, the term “COD” or “Chemical Oxygen Demand,” refers to a measure of the amount of oxygen required to fully oxidize the organic and inorganic contaminants in wastewater. COD measurement includes biologically labile, biologically inhibitory, and biologically refractory compounds.

A used herein, the term “unit” generally refers to a unit operation. A unit operation may be one or more basic operations in a process. A unit may have one or more sub-units (or subsystems). Unit operations may involve a physical change or chemical transformation, such as separation, crystallization, evaporation, filtration, polymerization, isomerization, other reactions, or combinations thereof. A unit may include one or more individual components.

As used herein, the terms “wastewater” and “wastewater stream” encompass any water to be treated such as surface water, ground water, and a stream of wastewater from industrial, agricultural, and municipal sources, having pollutants of biodegradable material, inorganic, labile organic compounds capable of being decomposed by bacteria, biologically refractory compounds, and/or biologically inhibitory compounds, flowing into a wastewater treatment system.

Reference will be made to the FIGURE to further describe the methods and systems of the present disclosure. It should be appreciated that the features illustrated in the FIGURE are not necessarily drawn to scale. In the FIGURE, the direction of fluid flow is indicated by arrows. Fluid may be directed from one unit to another, for example, with the aid of valves and a fluid flow system. As those of skill in the art will appreciate, such fluid flow systems may include compressors and/or pumps, as well as a control system for regulating fluid flow.

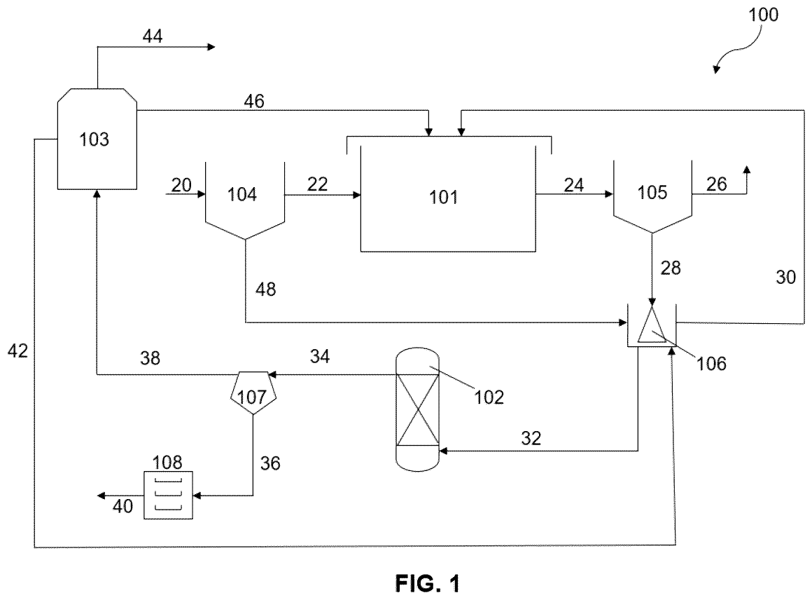

With reference to FIG. 1, a block flow diagram of a wastewater treatment system 100 is shown. The system 100 comprises a secondary treatment unit 101, a wet air oxidation (WAO) unit 102, and a digester 103.

In general, a wastewater stream 20 is subjected to a number of treatment stages upon initial entry into the system 100. A primary treatment phase may include mechanical means to remove large objects (e.g., bar screens), and a sand or grit channel where sand, grit, and stones settle. In accordance with the present disclosure, the system 100 may comprise a primary treatment unit 104 upstream from the secondary treatment unit 101, and a secondary clarifier 105 downstream from the secondary treatment unit 101. As shown in FIG. 1, the primary treatment unit 104 is configured to receive the inlet wastewater stream 20. The primary treatment unit 104 may comprise a settling tank, and provides an initial clarification stage in which large insoluble material of the water including, e.g., fats, oils, and grease, is removed or neutralized. A primary effluent stream 22 exits the primary treatment unit 104 and is directed to the secondary treatment unit 101. In embodiments of the system including a primary treatment unit, a primary sludge stream 48 exits the primary treatment unit 104 and is directed to the WAO unit 102. It should be understood that in accordance with the present disclosure, the primary treatment phase and primary treatment unit 104 are optional, and that the present inventive concepts also encompass directing a wastewater stream 20 directly to the secondary treatment unit 101, with or without any initial treatment upstream from the secondary treatment unit 101.

The secondary treatment unit 101 provides biological treatment to the wastewater. The primary effluent stream 22 is treated with bacteria within the secondary treatment unit 101. Biological treatment typically employs a biomass with bacteria or a consortium of microorganisms to at least partially hydrolyze or convert biodegradable material including, e.g., sugar, fat, organic molecules, and compounds that create an oxygen demand in the water. An activated sludge effluent stream 24 exits the secondary treatment unit 101 and is directed to the secondary clarifier 105. The secondary clarifier 105 may comprise gravity separation, such as a settling tank, or flotation or physical barrier, such as a membrane separation unit. The secondary clarifier 105 produces a treated water effluent stream 26 and a treated sludge stream 28. The treated water effluent stream 26 is discharged from the system for disposal or further use, e.g., discharged to freshwater ways, recovered, or reused.

The system 100 may comprise a solids thickening device 106 downstream from the secondary clarifier 105. The solids thickening device 106 functions to optimize the concentration of sludge solids upstream from the WAO unit 102. The solids thickening device 106 may comprise a centrifuge or a gravity belt thickener. It should be understood that the centrifuge can be substituted with any device suitable for separating an inlet slurry into separate high solids (i.e., slurry) portions and low solids (i.e., liquid) portions. The solids thickening device 106 is configured to separate the treated sludge stream 28 into a centrate stream 30 and a sludge solids stream 32. In accordance with the present disclosure, the centrate stream 30 may be recycled back to the secondary treatment unit 101 for further treatment.

With continued reference to FIG. 1, the system 100 comprises a wet air oxidation (WAO) unit 102 downstream from the solids thickening device 106. In accordance with the present disclosure, the WAO unit 102 is configured to treat the sludge solids stream 32. The WAO unit 102 comprises one or more dedicated reactor vessels, and provides aqueous phase oxidation of undesirable constituents by an oxidizing agent at an elevated temperature and pressure. The oxidizing agent may comprise molecular oxygen from an oxygen-containing gas, including, for example, a pressurized oxygen-containing gas supplied by a compressor. The oxidant may be added to the sludge solids stream 32 prior to, during, or after flow of the sludge solids stream 32 through a heat exchanger (not shown in FIG. 1). The inlet sludge solids stream 32 is thus treated in the WAO unit 102 to convert the volatile organic compounds in the sludge solids stream 32 into soluble biodegradable chemical oxygen demand (measured as biological oxygen demand, “BOD”), including carbon dioxide, water, and biodegradable short chain organic acids, such as acetic acid. The oxidation of the sludge solids in the WAO unit 102 maximizes the amount of soluble BOD in the system. Inorganic constituents including sulfides, mercaptides, and cyanides may also be oxidized. In some aspects, the oxidation process in the WAO unit is carried out at a temperature of 130° C. to 320° C., including from 150° C. to 300° C., including from 150° C. to 250° C., including from 150° C. to 200° C. In some aspects, the oxidation process in the WAO unit is carried out at a pressure of 8 to 220 bar, including from 10 to 200 bar.

In accordance with the present disclosure, a WAO effluent stream 34 exits the WAO unit 102 and is fed into a decanter 107. The decanter 107 produces a solid slurry stream 36 and a decanted liquid stream 38. It should be understood that the decanter 107 can be substituted with any device suitable for separating an inlet slurry into separate high solids (i.e., slurry) portions and low solids (i.e., liquid) portions. The decanted liquid stream 38 comprises soluble COD, including carbon dioxide, water, and biodegradable short chain organic acids, such as acetic acid. The solid slurry stream 36 comprises nitrogen and phosphorus. The solid slurry stream 36 may be directed to a dryer 108 to produce a sludge disposal stream 40. In some aspects, the decanted liquid stream 38 and/or the solid slurry stream 36 can be monitored for dissolved solids content, COD/BOD, or other identified characteristics. If the level of any one identified characteristic is not within a desired range or at a desired level, adjustments can be made to the WAO unit operating parameters. For example, if the COD of the solid slurry stream 36 deviates from a desired level or acceptable range, the operating temperature of the WAO unit can be adjusted to provide optimized conditions.

In accordance with the present disclosure, the decanted liquid stream 38 exits the decanter 107 and is directed to a digester 103. The digester 103 may comprise an aerobic or anaerobic digester. In some aspects, the digester 103 comprises an anaerobic digester. In some aspects, the digester 103 is configured to receive only the decanted liquid stream 38 as an inlet stream. The output from the digester 103 comprises a recycled sludge stream 42, a digester gas stream 44, and optionally a supernatant stream 46. The supernatant stream 46 may be recirculated to the secondary treatment unit 101 for further treatment.

The digester gas stream 44 exiting the digester 103 comprises methane, carbon dioxide, and hydrogen. In general, the digester gas stream 44 comprises a product fuel source, or said otherwise, a source of energy. For example, the digester gas stream 44 may provide fuel for a unit operation including, e.g., a boiler or generator set (“genset”) device. If desired, the digester gas stream 44 may be further processed to provide an export from the system.

In accordance with the present disclosure, the recycled sludge stream 42 is directed back into the system for separation in the solids thickening device 106 upstream from the WAO unit 102. Thus, in some aspects, the inlet lines to the solids thickening device 106 comprise the treated sludge stream 28, the recycled sludge stream 42, and, optionally, the primary sludge stream 48.

Notably, conventional wastewater treatment facilities do not include a WAO unit, and as such, rely wholly on anerobic digestion to treat the sludge stream after the initial clarification and centrifugation stages. In order to effectively treat this high volume of organic compounds in the inlet sludge stream, the anerobic digester in these conventional systems may require a residence time of 7 to 10 days, or in some cases even up to 100 days. Likewise, conventional systems rely on micro-organisms to perform the different stages of anerobic digestion, including hydrolysis, acidogenesis, acetogenesis, and methanogenesis. Further, conventional processes result in a sludge disposal stream that is high in volatile organic compounds, in addition to the presence of contaminants such as PFAS. Moreover, the total volume of sludge requiring disposal is high.

In contrast, the inventors have surprisingly found that including a wet air oxidation treatment step upstream from the digester results in substantial processing efficiencies, as detailed in the following paragraphs.

First, by separating out the treatment of organic compounds in the sludge stream via wet air oxidation, the residence time required in the digester is reduced to approximately 8-12 hours. This is because in conventional wastewater treatment facilities, the anaerobic digestion process normally occurs in two steps: first organic material is converted to carboxylic acids, which are then converted to methane and carbon dioxide, entirely by the bacteria. The rate limiting step of this conventional process within the digester is the conversion of organic material to carboxylic acids. In accordance with the wastewater treatment system 100 described herein, though, the conversion of organic material is completed simultaneously as the sludge is dissolved. Specifically, only the methanogenesis stage of anerobic digestion occurs post-wet air oxidation. As such, the wastewater treatment system 100 operates in a continuous fashion, as opposed to a batch process. Accordingly, the volume requirements for a digester in the disclosed wastewater treatment system is substantially lower than in conventional processes.

Further, the final volume of output waste sludge requiring costly disposal is substantially lowered in the disclosed system 100 as compared to conventional wastewater treatment processes. This is because the volume of organic compounds, such as carbon, from the original inlet wastewater stream 20 that are converted into methane in the digester gas stream 44 exiting the system is substantially higher than conventional wastewater treatment processes. Said otherwise, the wastewater treatment system disclosed herein converts the majority of the carbon from the original inlet wastewater stream into useable fuel, as opposed to sludge waste requiring disposal.

This effect can be observed by measuring the efficiency of the sludge process at the digester stage. Specifically, the improvements in the disclosed system can be quantified by measuring the reduction in the volatile solids (VSR) that occurs from the original wastewater stream 20 to the digester gas stream 44 exiting the digester 103. For example, in conventional wastewater systems, the observed volatile solids reduction is approximately 20%, when accounting for solids formed in the digester and requiring disposal. However, in the disclosed system including a wet air oxidation treatment step upstream from the digester, as well as a means for the recycled sludge stream 42 back into the system, it has been found that a substantially higher proportion of the organic compounds from the original inlet wastewater stream 20 can be converted to methane in the digester gas stream 44 exiting the system. In some aspects, the reduction in the volatile solids (VSR) that occurs from the original wastewater stream 20 to the digester gas stream 44 is at least 50%, including at least 70%, including at least 75%, including at least 80%, including at least 90%.

As noted, a high proportion of the organic compounds from the original inlet wastewater stream 20 are converted to methane and carbon dioxide in the digester gas stream 44. The digester gas stream 44 can be processed, if desired, to provide a product fuel source, i.e., for energy production or chemical manufacturing. The digester gas stream 44 can be utilized as a fuel source for one or more unit operations of the treatment system, or alternatively, can be sold to outside facilities as a source of energy. Accordingly, when compared to conventional wastewater treatment processes, the wastewater treatment system 100 depicted in FIG. 1 produces a substantial reduction in the volume of solid sludge requiring costly disposal, in favor of increasing the volume of product fuel that can be utilized or sold to outside facilities.

Finally, the output sludge requiring disposal comprises a significantly reduced volume of water as compared to conventional wastewater treatment systems. Given that PFAS are soluble in water and thus believed to be predominantly transported in the water phase of sludge, the reduced volume of water in the sludge disposal stream 40 as compared to conventional systems results in a reduction in soluble contaminants such as PFAS.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The methods and systems of the present disclosure can comprise, consist of, or consist essentially of the essential elements of the disclosure as described herein, as well as any additional or optional element described herein, or which is otherwise useful in wastewater treatment applications.

In accordance with the present disclosure, it is possible to utilize the various inventive concepts in combination with one another. Additionally, any particular feature recited as relating to a particularly disclosed aspect of the methods and systems of the present disclosure should be interpreted as available for use with all disclosed aspects of the methods and systems of the present disclosure, unless incorporation of the particular feature would be contradictory to the express terms of the disclosed aspect. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

### EXAMPLES

The following examples are included for the purposes of illustration, and do not limit the scope of the general inventive concepts described herein.

### Example 1

A wastewater stream was treated on a pilot scale in a wastewater treatment system as depicted in FIG. 1, including, e.g., the use of a wet air oxidation (WAO) unit 102 upstream from a digester 103. As detailed in Table 1, the oxidation conditions were restricted in an effort to maximize the amount of sludge solids that became soluble, while keeping the soluble COD/BOD as high as possible.

TABLE 1
The Effect of Oxidation Temperature On Volume Of Sludge Solids

| | Oxidation Temperature | | | | | | | | | |
|---|---|---|---|---|---|---|---|---|---|---|
| | | — | | | | | | | | |
| Analysis | ° C. | Reported | | | | | | | | |
| Results | Units | As | — | 150 | 160 | 170 | 175 | 180 | 150 | 200 |
| COD | mg/L | O₂ | 35.300 | 30.600 | 29.600 | 29.800 | 26.700 | 27.200 | 23.500 | 16.700 |
| COD Reduction | % | — | — | 13% | 16% | 16% | 24% | 23% | 33% | 53% |
| S. COD | mg/L | O₂ | 1.280 | 14.000 | 16.200 | 18.400 | 17.500 | 19.400 | 17.900 | 16.700 |
| Suspended Solids | mg/L | C | 28.700 | 14.300 | 11.300 | 9.540 | 7.290 | 6.780 | 5.760 | 5.540 |
| Volatile Solids | mg/L | | 24.200 | 11.000 | 8.340 | 6.340 | 4.570 | 3.800 | 2.920 | 2.440 |
| Suspended Ash | mg/L | C | 4.500 | 3.300 | 2.960 | 3.200 | 2.720 | 2.980 | 2.840 | 3.100 |
| Suspended Solids | | | | | | | | | | |
| Reduction | % | — | — | 50% | 61% | 67% | 75% | 76% | 80% | 81% |
| Specific Filtration | | | | | | | | | | |
| Resistance (SFR) | ×10⁷ sec²/g | | — | 6.798 | 221 | 47 | 31 | 54 | 134 | 178 |
| pH | — | — | 6.3 | 4.5 | 4.2 | 4.0 | 3.9 | 3.9 | 4.0 | 4.4 |

As shown in Table 1, varying operating temperatures for the WAO unit were observed in order to assess the effect of oxidation temperature on the volume of sludge solids. Specifically, in accordance with the present disclosure, the goal of the analysis was to minimize COD in the solids phase and maximize COD in the liquid phase.

While each of the operating temperatures set forth in Table 1 provide efficient wastewater treatment in accordance with the present disclosure, it was found that a WAO operating temperature of 175° C. provided optimized conditions. In that sample, the soluble COD was 1,280 mg/L in the inlet sludge. After oxidation at 175° C., the soluble COD increased to 17,500 and the pH of the solution decreased to 4.0, given the formation of organic acids. The amount of volatile suspended solids in the slurry was reduced from 24,200 mg/L to 4,570 mg/L. Accordingly, the suspended solids were reduced by 75%, while maintaining high soluble COD/BOD.

What is claimed is:

1. A method of treating wastewater, the method comprising:
(a) directing a wastewater stream into a secondary treatment unit, wherein the secondary treatment unit provides biological treatment of the wastewater stream and produces a treated sludge stream;
(b) directing the treated sludge stream into a solids thickening device, wherein the solids thickening device separates the treated sludge stream into a centrate stream and a sludge solids stream;
(c) directing the sludge solids stream into a wet air oxidation (WAO) unit, wherein the WAO unit solubilizes the sludge solids stream by wet air oxidation to provide a WAO effluent stream;
(d) separating the WAO effluent stream into a solid slurry stream and a decanted liquid stream; and
(e) directing the decanted liquid stream into a digester, wherein the decanted liquid stream is subjected to anaerobic digestion to produce a digester gas stream, and wherein the digester gas stream comprises methane, carbon dioxide, and hydrogen.

2. The method of claim 1, further comprising removing a recycled sludge stream from the digester, and directing the recycled sludge stream into the solids thickening device.

3. The method of claim 1, further comprising processing the digester gas stream to provide a product methane source.

4. The method of claim 1, further comprising directing the solid slurry stream to a dryer to produce a sludge disposal stream.

5. The method of claim 1, further comprising removing a supernatant stream from the digester, and directing the supernatant stream into the secondary treatment unit.

6. The method of claim 1, further comprising directing the centrate stream into the secondary treatment unit.

7. The method of claim 1, further comprising clarifying the wastewater stream in a primary treatment unit upstream from the activated sludge unit.

8. The method of claim 1, further comprising clarifying the treated sludge stream in a secondary clarifier upstream from the solids thickening device.

9. The method of claim 1, wherein the method achieves a reduction in volatile solids (VSR) from the wastewater stream to the digester gas stream of at least 50%.

10. The method of claim 1, wherein the wet air oxidation of the sludge solids stream in the WAO unit is carried out at a temperature of 130° C. to 320° C.

11. A wastewater treatment system, the system comprising:
(a) a secondary treatment unit configured to provide biological treatment of a wastewater stream;
(b) a wet air oxidation (WAO) unit downstream from the secondary treatment unit, wherein the WAO unit is configured to solubilize a sludge solids stream by wet air oxidation to provide a WAO effluent stream;
(c) a means for separating the WAO effluent stream into a solid slurry stream and a decanted liquid stream; and
(d) a digester downstream from the WAO unit, wherein the digester is configured to subject the decanted liquid stream to anaerobic digestion to produce a digester gas stream, and wherein the digester gas stream comprises methane, carbon dioxide, and hydrogen.

12. The system of claim 11, further comprising a recycled sludge stream configured to flow from the digester into a solids thickening device upstream from the WAO unit.

13. The system of claim 12, wherein the solids thickening device is configured to provide the sludge solids stream and a centrate stream.

14. The system of claim 12, wherein the sludge solids stream is configured to flow from the solids thickening device into the WAO unit.

15. The system of claim 11, further comprising a dryer configured to process the solid slurry stream to produce a sludge disposal stream.

16. The system of claim 11, further comprising a supernatant stream configured to flow from the digester into the secondary treatment unit.

17. The system of claim 13, wherein the centrate stream is configured to flow from the solids thickening device into the secondary treatment unit.

18. The system of claim 11, further comprising a primary treatment unit upstream from the secondary treatment unit.

19. The system of claim 11, further comprising a secondary clarifier downstream from the secondary treatment unit and upstream from the WAO unit.

20. The system of claim 11, wherein the digester is configured to receive only the decanted liquid stream as an inlet stream.
